(19) United States
(12) Patent Application Publication
(10) Pub. No.: US 2008/0263484 A1
(43) Pub. Date: Oct. 23, 2008

(54) Layout verification program, layout data and cell data

(75) Inventor: Yoshikazu Kobayashi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/078,613

(22) Filed: Apr. 2, 2008

(30) Foreign Application Priority Data
Apr. 19, 2007 (JP) 2007-110660

(51) Int. Cl. G06F 17/50

(52) U.S. Cl. 716/5

(57) ABSTRACT

A layout verification program recorded on a computer-readable medium causes a computer to perform verification processing of a layout data of a semiconductor integrated circuit in which a plurality of cells are placed. The layout data includes a first identification layer in which predetermined patterns are placed. The predetermined patterns include: a first pattern placed on one corner of each cell; and a second pattern placed parallel to one side of each cell. The verification processing includes: (A) reading the layout data and a design rule from a memory device; (B) identifying an orientation of each cell by reference to the first pattern; (C) identifying a direction of each cell by reference to the second pattern; and (D) verifying whether or not the identified orientation and direction meet the design rule.

### BACKGROUND OF THE INVENTION

1. Field of the Invention

The present invention relates to a layout technique and a layout verification technique of a semiconductor integrated circuit.

This application is based upon and claims the benefit of priority from Japanese patent application No. 2007-110660, filed on Apr. 19, 2007, the disclosure of which is incorporated herein in its entirely by reference.

2. Description of Related Art

In a design process of a semiconductor integrated circuit, a layout data thereof is generated and then layout verification is performed for verifying whether or not the generated layout data meets a design rule. The followings are known as methods for identifying elements and terminals included in the layout data at the time of the layout verification.

Japanese Laid-Open Patent Application JP-Syowa-63-36553 discloses an element identification system of an integrated circuit artwork data. The element identification system reproduces a circuit by reference to type names of respective terminals and names of respective cells that are rectangular data in the artwork data. More specifically, the element identification system realizes text representation by combining cell names and text names of the lower hierarchy included in a common region, in accordance with diffusion patterns of the artwork data. As a result, a plurality of elements included in one cell can be identified.

Japanese Laid-Open Patent Application JP-P2000-268077 discloses a method for identifying plural kinds of MOS transistors that have the same layout structure at the time of the layout verification. According to the method, graphic symbols having arbitrary shapes and respectively placed in two different layers are used as an identification pattern for identifying the MOS transistors. The graphic symbols in the respective layers are in contact with each other at at least one side through the two layers. The identification pattern is placed at the time when the layout data is generated. The number of the contact sides in the identification pattern is different depending on a minimum gate length of the MOS transistor. At the time of the layout verification, the identification pattern is extracted from the layout data, and a type of the MOS transistor is identified based on the number of the contact sides in the extracted identification pattern.

The inventor of the present application has recognized the following points. A plurality of cells are placed in a layout of a semiconductor integrated circuit. In a layout of an SRAM, for example, a plurality of bit cells associated with a memory cell array are placed in a matrix form. With regard to such a layout in which a plurality of cells are placed, a technique which can improve efficiency of the layout verification is desired.

### SUMMARY

In one embodiment of the present invention, a cell data is provided with identification layers used for identifying the cell at the time of layout verification. The identification layers include a first identification layer in which predetermined patterns are placed. The predetermined patterns include: a first pattern placed on one corner of the cell; and a second pattern placed parallel to one side of the cell.

In layout processing, the above-mentioned cell data is read out and cell placement is performed by using the cell data. As a result, a layout data of a semiconductor integrated circuit in which a plurality of cells are placed is generated. The generated layout data is provided with the above-mentioned identification layers.

At the time of the layout verification, the arrangement of the plurality of cells is verified by reference to the identification layers. Here, various items can be verified with ease by reference to the above-mentioned first pattern and second pattern. For example, it is possible to identify and verify an orientation of each cell by reference to the first pattern. It is also possible to identify and verify a direction of each cell by reference to the second pattern. In this manner, whether or not the layout data meets a design rule can be verified from various points of view by reference to the first pattern and the second pattern. The identification layer provided with the first pattern and the second pattern according to the present invention can be said to be versatile.

As described above, the versatile identification layer is provided according to the present invention. Therefore, the items that can be verified in the layout verification are increased, which improves a verification rate. Moreover, since the identification layer is versatile, it is not necessary to fix a relationship between a cell library and a verification specification (DRC rule). It is possible to change or add the verification specification even after the cell library is released. In other words, the cell library needs not be recreated in accordance with the change/addition of the verification specification. The identification layer according to the present invention can support the change/addition of the verification specification.

According to the present invention, the layout data is provided with the versatile identification layer and thus efficiency of the layout verification is improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a conceptual diagram for explaining identification layers in an embodiment of the present invention;

FIG. 2 is a conceptual diagram showing an example of an identification layer Layer-A in the present embodiment;

FIG. 3 is a conceptual diagram showing an example of an identification layer Layer-B in the present embodiment;

FIG. 4A is a conceptual diagram showing an example of an identification layers Layer-C in the present embodiment;

FIG. 4B is a conceptual diagram showing another example of the identification layer Layer-C in the present embodiment;

FIG. 5 is a flowchart showing a method of designing a semiconductor integrated circuit according to the present embodiment;

FIG. 6 is a conceptual diagram showing a layout data in the present embodiment;

FIG. 7 is a conceptual diagram for explaining Arrangement verification in the present embodiment;

FIG. 8 is a conceptual diagram for explaining Orientation verification in the present embodiment;

FIG. 9 is a conceptual diagram for explaining Direction verification in the present embodiment;

FIG. 10 is a conceptual diagram for explaining Size verification in the present embodiment; and

FIG. 11 is a block diagram showing a configuration example of a design system for designing a semiconductor integrated circuit according to the present embodiment.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A layout technique and a layout verification technique according to an embodiment of the present invention will be described below with reference to the attached drawings.

### 1. Identification Layer

First, “identification layers” used in the present embodiment will be explained. The identification layers are embedded in a cell data and used for identifying the cell at the time of layout verification. According to GDS (Graphic Design Standard)-II format which is well known and generally used for the cell data and layout data, a plurality of layers are defined. Some of the plurality of layers are used as the identification layers in the present embodiment.

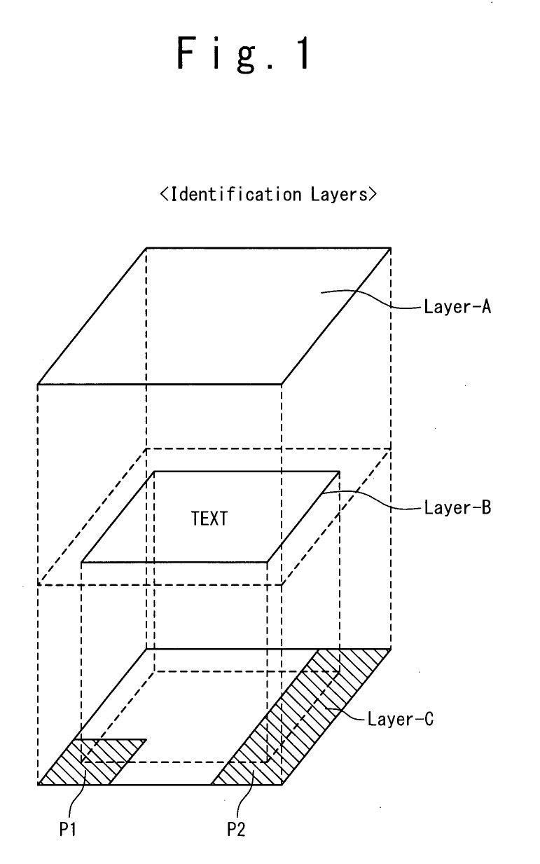

FIG. 1 conceptually shows the identification layers that a cell data has. The cell data is, for example, a data of a cell (hereinafter referred to as a “bit cell”) corresponding to one memory element of an SRAM. As shown in FIG. 1, the cell data is provided with three identification layers Layer-A, Layer-B and Layer-C.

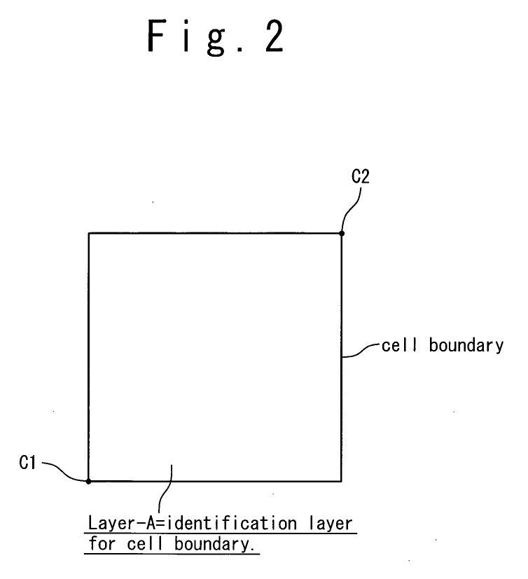

FIG. 2 conceptually shows the Layer-A that is one of the identification layers. The Layer-A is an identification layer that represents a boundary (outer shape) of the cell. For example, the Layer-A can be defined by coordinates of two diagonal points C1 and C2 on a rectangle representing the cell boundary. In cell placement processing where a plurality of cells are placed, each cell is so placed as to contact with another cell at the cell boundary.

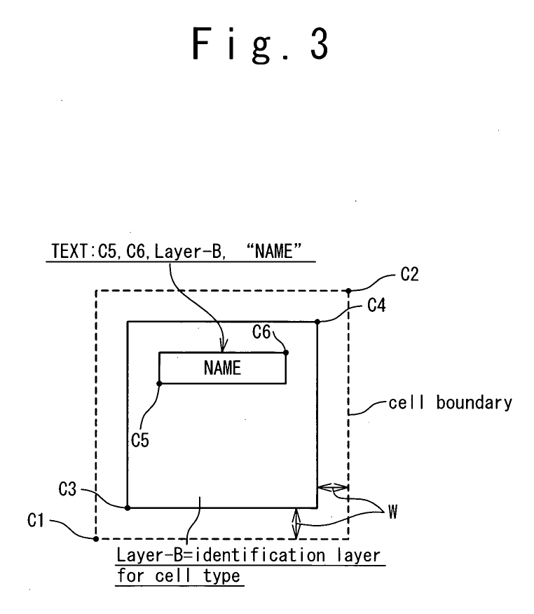

FIG. 3 conceptually shows the Layer-B that is one of the identification layers. The Layer-B is an identification layer that indicates a type of the cell and is used for identifying the cell type. For example, the Layer-B can be defined by coordinates of two diagonal points C3 and C4 on a rectangle.

Information used for identifying the cell type is written to the Layer-B. In the present embodiment, for example, the standard “TEXT” defined by the GDS-II format is given to the Layer-B of each cell. That is to say, the “TEXT” is written at a predetermined position within the rectangle defined by the above-mentioned two diagonal points C3 and C4. A name which is different depending on the cell type is given as the “TEXT”. In the example shown in FIG. 3, a name associated with the cell type is written in a rectangular area defined by two diagonal points C5 and C6. By specifying the Layer-B (layer number) and a certain name (TEXT), it is possible to select the Layer-B to which the specified name is written, namely, cells of the specified type. The Layer-B can be said to be an identification layer used for selecting cells with the specified name (specified type).

It should be noted that the rectangular defined by the two diagonal points C3 and C4 is within the cell boundary defined by the above-mentioned two diagonal points Cl and C2, as shown in FIG. 3. In other words, a boundary of the Layer-B of each cell is away from the boundary of each cell. The reason is as follows. If the boundary of the Layer-B coincides (overlaps) with the cell boundary, the respective Layer-B of adjacent cells come in contact with each other when cells are placed. In this case, the adjacent cells will be selected together when the Layer-B to which the specified name is written is selected. In other words, not only a cell with the specified name but also its adjacent cell with a different name may be selected. In order to prevent such the erroneous selection, the boundary of the Layer-B is set away from the cell boundary. For example, the boundary of the Layer-B is away from the cell boundary by a width W (e.g. 0.01 micrometer), as shown in FIG. 3. Consequently, it becomes possible to correctly select cells with the specified name (specified type).

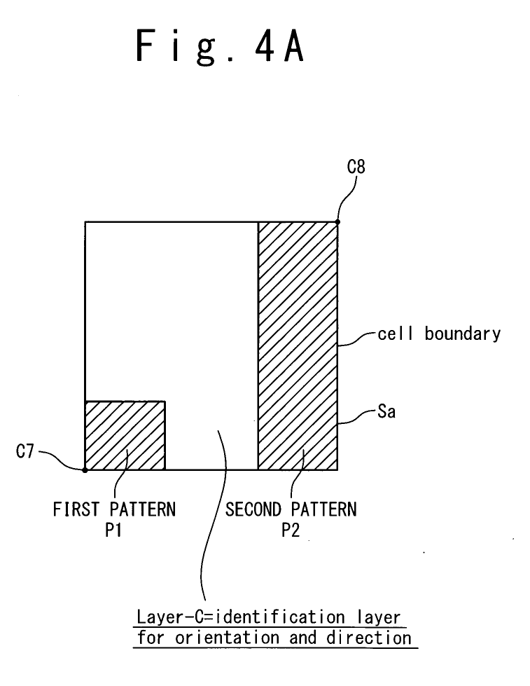

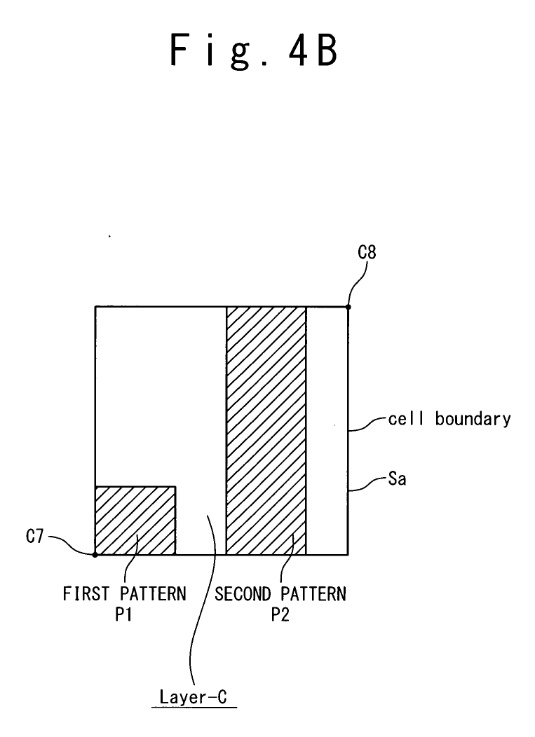

FIG. 4A conceptually shows the Layer-C that is one of the identification layers. For example, the Layer-C can be defined by coordinates of two diagonal points C7 and C8 on a rectangle. The rectangle defined by these two diagonal points C7 and C8 coincides (overlaps) with the above-mentioned cell boundary. The Layer-C is an identification layer used for identifying such information as an orientation and a direction of the cell. In order to identify the information, predetermined patterns are placed in the Layer-C. For example, a first pattern P1 and a second pattern P2 are placed in the Layer-C shown in FIG. 4A.

The first pattern P1 is placed on one corner of each cell. In the example shown in FIG. 4A, the first pattern P1 is placed on the corner of the above-mentioned point C7. The first pattern P1 is a pattern that indicates the orientation of the cell. The orientation of the cell is changed due to flipping and/or rotating at the time of the cell placement. Based on the position of the first pattern P1, it is possible to identify the cell orientation including flipping and/or rotating.

The second pattern P2 is placed parallel to one side of each cell. In the example shown in FIG. 4A, the second pattern P2 is so placed as to be parallel to one side Sa of the cell and adjacent to the side Sa. The second pattern P2 is a pattern that indicates the direction of the cell. In the case of the bit cell of the SRAM, for example, a longitudinal direction of the second pattern P2 indicates a digit line direction or a word line direction. It is also possible that the second pattern P2 is just parallel to the side Sa without being adjacent to the side Sa, as shown in FIG. 4B.

Note that both of the first pattern P1 and the second pattern P2 are so placed as to overlap with at least a part of the above-mentioned Layer-B (refer to FIG. 1).

In the cell data (layout data), the first pattern P1 and the second pattern P2 may be originally away from the cell boundary, namely, the rectangle defined by the two diagonal points C7 and C8 may be away from the cell boundary. In this case, the original first pattern P1 and second pattern P2 are modified in the layout verification stage. More specifically, after the original first pattern P1 and second pattern P2 are identified in the layout data, they are respectively modified to be the first pattern P1 and the second pattern P2 as shown in FIG. 4A or FIG. 4B.

### 2. Processing Flow

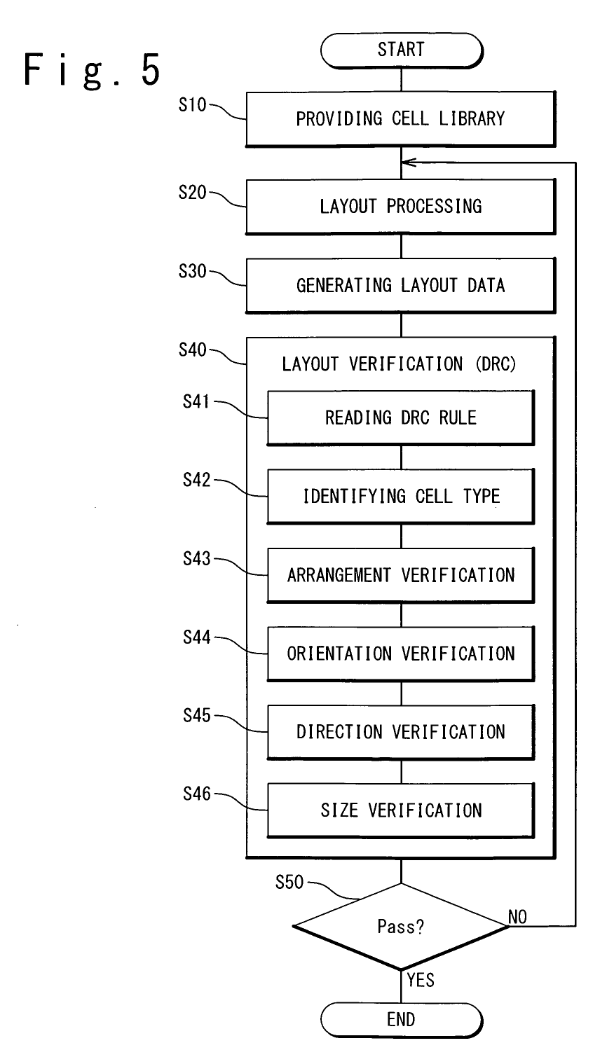

Described next will be a method of designing a semiconductor integrated circuit with the use of the above-mentioned cell data provided with the identification layers (Layer-A, Layer-B and Layer-C). FIG. 5 is a flowchart showing the method of designing a semiconductor integrated circuit according to the present embodiment.

Step S10:

First, a cell library is provided. The cell library consists of plural kinds of cell data associated with plural types of cells, respectively. Each cell data is given in the GDS-II format. Moreover, each cell data is provided with the identification layers Layer-A, Layer-B and Layer-C shown in FIG. 1.

Step S20:

Next, layout processing is performed. In the layout processing, a plurality of cells are placed in accordance with a netlist indicating a circuit design. In the case of SRAM, for example, a plurality of bit cells are placed in a matrix form. The cell data of the necessary cells are read from the cell library. In the cell placement processing, each of the plurality of cells is so placed as to contact with another cell at the cell boundary specified by the Layer-A.

Step S30:

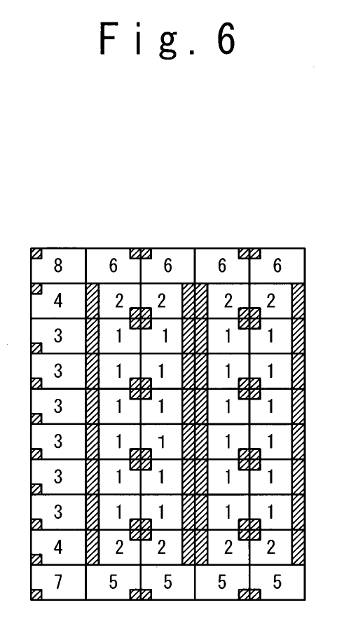

As a result of the foregoing Step S20, a layout data (GDS data) that indicates the determined layout of the design circuit is generated. The layout data is also given in the GDS-II format and provided with the above-mentioned identification layers (Layer-A, Layer-B and Layer-C). FIG. 6 conceptually shows the layout data that is generated. The layout data of an SRAM is illustrated as an example. In the layout of the SRAM, plural types of cells (denoted by reference numerals 1 to 8 respectively) are placed.

The reference numerals 1 and 2 indicate bit cells. A plurality of bit cells 1 and 2 are placed in a matrix form corresponding to a memory cell array. The bit cell 2 is a cell located at the end of the cell array, while the bit cell 1 is a cell located at an internal portion of the cell array. Although the bit cell 2 has the same circuit configuration as the bit cell 1, the bit cell 2 on the layout is treated as a different type cell from the bit cell 1 because the bit cell 2 is placed at the end of the cell array. In the bit cells 1 and 2, the Layer-C has both of the patterns P1 and P2 shown in FIG. 4A. In the present embodiment, the bit cells (1, 2) are placed such that the longitudinal direction of the second pattern P2 coincides with a digit-line direction of the SRAM.

The reference numerals 3 and 4 indicate connection cells each of which connects between a bit cell and a decoder. The connection cell 3 connects between the bit cell 1 and the decoder, while the connection cell 4 connects between the bit cell 2 and the decoder. The reference numeral 5 indicates a connection cell that connects between the bit cell 2 and another decoder. The reference numeral 6 indicates a connection cell that connects between the adjacent cell arrays. The reference numerals 7 and 8 indicate other cells. In the cells 3 to 8, the Layer-C has only the first pattern P1.

As shown in FIG. 6, some of the plurality of cells are placed after being flipped or rotated. The flipping and rotating are required from design circuit specification. For example, a certain bit cell (1 or 2) has the “flipped” relation with another bit cell adjacent to the certain bit cell. That is to say, a bit cell and a flipped bit cell are placed alternately either in a longitudinal direction or a transverse direction. Consequently, as shown in FIG. 6, respective first patterns P1 of four bit cells adjacent to each other are adjacent to each other, and thus a large square pattern consisting of the four first patterns P1 is formed. Moreover, there exists a group of bit cells each of whose second pattern P2 is adjacent to another second pattern P2 of the adjacent bit cell. As shown in FIG. 6, respective second patterns P2 of two bit cells adjacent to each other are facing and adjacent to each other, and thereby a thick strip pattern consisting of the second patterns P2 is formed. The large square pattern and the thick strip pattern appear regularly.

Step S40:

After the layout data is generated, the layout verification (DRC: Design Rule Check) is performed. In the layout verification, whether the layout data meets the design rule or not is verified (checked). First, a DRC rule is read (Step S41). The DRC rule is a specification of the layout verification and includes various design rules that the layout data should meet.

Next, the type of each cell is identified by reference to the “TEXT” which is written to the Layer-B of each cell (Step S42). By specifying the Layer-B (layer number) and a certain name (TEXT), it is possible to identify the Layer-B to which the specified name is written, namely, cells of the specified type. As shown in FIG. 6, the various types of cells 1 to 8 are placed in the layout data. Subsequently, verifications of arrangement, orientation, direction and the like of the identified cells are performed as explained below.

Step S43: Verification of Arrangement

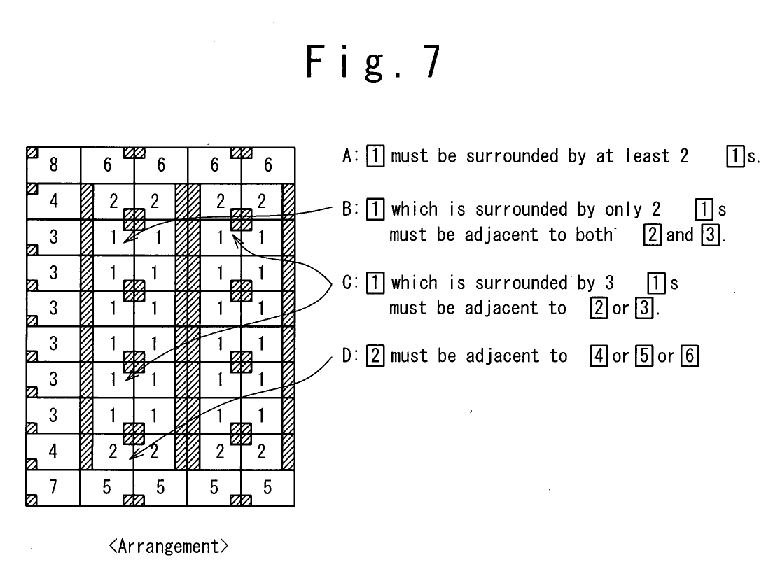

FIG. 7 is a conceptual diagram for explaining verification of an arrangement of the plurality of cells. In the verification of cell arrangement, combinations of adjacent cells are verified (checked). That is to say, whether or not the types of cells adjacent to each other meet the DRC rule is verified. The type of each cell is identified in the foregoing Step S42, and the verification of cell arrangement is executed based on the identified cell type.

For example, the following items are verified in the present step (see also FIG. 7): (A) whether or not a bit cell 1 is surrounded by at least two bit cells 1; (B) whether or not a bit cell 1 surrounded by only two bit cells 1 is adjacent to both of a bit cell 2 and a connection cell 3; (C) whether or not a bit cell 1 surrounded by three bit cells 1 is adjacent to a bit cell 2 or a connection cell 3; (D) whether or not a bit cell 2 at the end of the cell array is adjacent to any one of connection cells 4, 5 and 6; and so on. These items can be verified based on the identified cell type.

It should be noted that in the internal portion of the cell array, there exists a group of bit cells each of whose second pattern P2 is facing and adjacent to another second pattern P2 of the adjacent bit cell, as described above. As a result, the thick strip pattern is formed in the internal portion of the cell array. On the other hand, a thin strip pattern is formed at the end portion of the cell array adjacent to the connection cells 3 and 4. It is therefore possible to distinguish the end portion and the internal portion of the cell array based on the thickness of the strip pattern consisting of the second patterns P2. That is to say, it is possible to easily identify the end portion and the internal portion of the cell array with reference to the second pattern P2 in the Layer-C. To realize such the identification, the group of bit cells each of whose second pattern P2 is facing and adjacent to another second pattern P2 of the adjacent bit cell is necessary. In this regard, it is preferable that the second pattern P2 is adjacent to the one side Sa as shown in FIG. 4A.

Step S44: Verification of Orientation

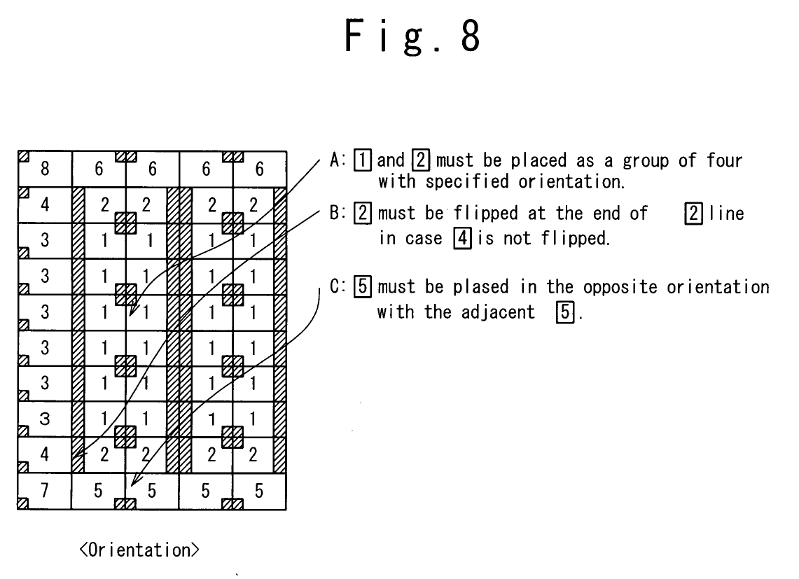

FIG. 8 is a conceptual diagram for explaining verification of an orientation of each cell. The cell orientation is changed due to the flipping and/or rotating at the time of the cell placement. It is possible to identify the cell orientation including the flipping and/or rotating by reference to the position of the first pattern P1 in the Layer-C. Whether or not the identified orientation of each cell meets the DRC rule associated with the cell type is verified.

For example, the following items are verified in the present step (see also FIG. 8): (A) whether four bit cells (1, 2) respectively having different orientations are adjacent to each other to constitute one group; (B) whether a bit cell 2 at the end is flipped in a case where a connection cell 4 is not flipped; (C) whether respective orientations of two adjacent connection cells 5 are opposite to each other; and so on. These items can be verified based on the identified cell types and the respective first patterns P1.

As for the item (A), the above-mentioned “large square pattern” can be referred to. As described above, a bit cell and a flipped bit cell are placed alternately either in the longitudinal direction or the transverse direction. Therefore, it is expected that respective first patterns P1 of four bit cells adjacent to each other are also adjacent to each other, and thereby the large square pattern consisting of the four first patterns P1 is formed. Checking whether the large square pattern is formed or not is equivalent to verifying the above item (A), i.e., verifying whether or not the respective orientations of the four bit cells meet the DRC rule. The item (A) can be easily verified by detecting the large square pattern in the Layer-C of the layout data.

Step S45: Verification of Direction

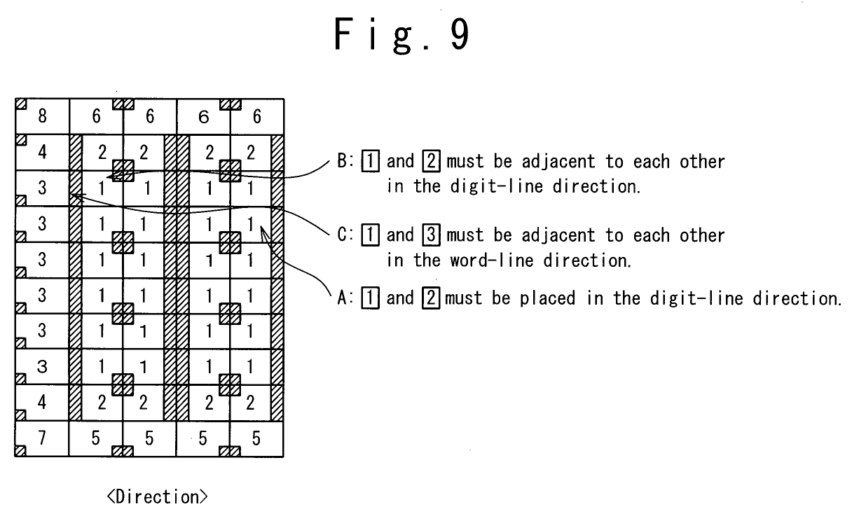

FIG. 9 is a conceptual diagram for explaining verification of a direction of cell. It is possible to identify the direction of each cell by reference to the second pattern P2 in the Layer-C. Whether or not the identified direction of each cell and the identified direction of a group of cells meet the DRC rule is verified. In particular, a group of bit cells in the cell array are placed serially in a predetermined direction. Therefore, whether or not the direction of the group of bit cells meets the DRC rule is verified.

For example, the following items are verified in the present step (see also FIG. 9): (A) whether or not bit cells (1, 2) are placed in the digit-line direction; (B) whether or not a bit cell 1 and a bit cell 2 are adjacent to each other in the digit-line direction; (C) whether or not a bit cell 1 and a connection cell 3 are adjacent to each other in the word-line direction; and so on. In the present embodiment, as described above, the bit cells (1, 2) are supposed to be placed such that the longitudinal direction of the second pattern P2 coincides with the digit-line direction. That is to say, the longitudinal direction of the second pattern P2 is expected to be the same as the digit-line direction. Therefore, the above items (A) to (C) can be verified based on the identified cell types and the respective second patterns P2.

Step S46: Verification of Size

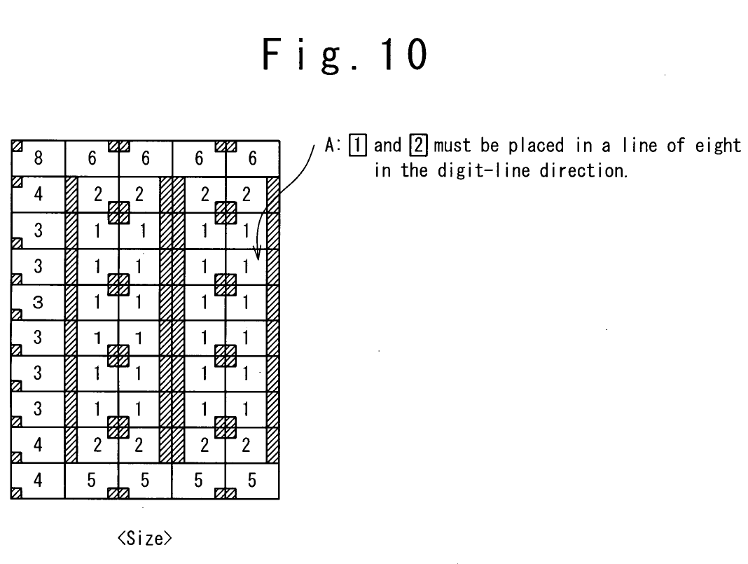

FIG. 10 is a conceptual diagram for explaining verification of a size of the cell group. The verification of the size is closely related to the verification of the direction in the above-mentioned Step S45. That is, whether or not the number of cells included in the above-mentioned group of cells which are placed serially in the predetermined direction meets the DRC rule is verified based on the identified cell types and the second pattern P2. In the example shown in FIG. 10, whether or not eight bit cells (1, 2) are placed serially in the digit-line direction is verified based on the identified cell types and the second pattern P2. That is, verification of the size of bit cells for each cell array is performed. The size of bit cells for each cell array is determined, for example, from a viewpoint of sufficient power supply.

Referring to FIG. 5 again, if the result of the layout verification is “FAIL” (Step S50; No), the processing returns back to Step S20 and the layout processing is performed again. If the result of the layout verification is “PASS” (Step S50; Yes), the processing is ended.

### 3. Effect

According to the present embodiment, as described above, whether or not the layout data meets the design rule can be verified from various points of view by reference to the first pattern P1 and the second pattern P2. The identification layer (Layer-C) provided with the first pattern P1 and the second pattern P2 can be said to be versatile. Such the versatile identification layer can support various verification items. That is to say, the items that can be verified in the layout verification are increased, which improves a verification rate.

Moreover, since the identification layer is versatile, it is not necessary to fix a relationship between the cell library and the verification specification (DRC rule). It is possible to change or add the verification specification even after the cell library is released. In other words, the cell library needs not be recreated in accordance with the change/addition of the verification specification. The identification layer according to the present embodiment can support the change/addition of the verification specification.

According to the present embodiment, the layout data is provided with the versatile identification layer and thus efficiency of the layout verification is improved.

### 4. Design System

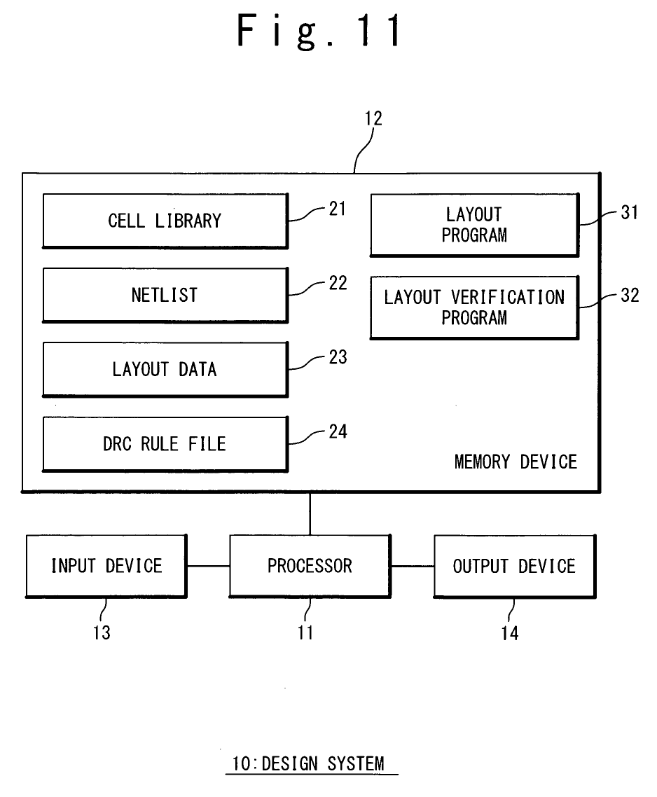

FIG. 11 is a block diagram showing a configuration of a design system 10 for realizing the above-mentioned layout processing and layout verification processing. The design system 10 is a computer system and is provide with a processor 11, a memory device 12, an input device 13 and an output device 14. The memory device 12 is exemplified by a RAM and a hard disk drive. The input device 13 is exemplified by a keyboard and a mouse. The output device 14 is exemplified by a display.

A cell library 21, a netlist 22, a layout data 23, a DRC rule file 24, a layout program 31 and a layout verification program 32 are stored in the memory device 12.

The cell library 21 consisting of a plurality kinds of cell data is provided in the above-mentioned Step S10. The cell library 21 may be recorded on a computer-readable recording medium and read out from the recording medium to the memory device 12. The netlist 22 indicating connection information of elements in a design circuit is used in the layout processing (Step S20). The layout data 23 indicating a layout of the design circuit is generated in the above-mentioned Step S30. The generated layout data 23 may be recorded on a computer-readable recording medium. The DRC rule file 24 indicates the DRC rule that is used in the layout verification processing (Step S40). According to the present embodiment, it is possible to change or add the DRC rule file 24 even after the cell library 21 is provided.

The layout program 31 is a computer program that is executed by the processor 11. The layout program 31 may be recorded on a computer-readable recording medium and read out from the recording medium to the memory device 12. The layout processing (Step S20) according to the present embodiment is realized by cooperation of the layout program 31 and the processor 11. More specifically, in accordance with instructions of the layout program 31, the processor 11 reads the cell library 21 and the netlist 22 from the memory device 12 and then places a plurality of cells by referring to the netlist 22 and using the cell data included in the cell library 21. As a result, the layout data 23 of the design circuit in which the plurality of cells are placed is generated.

The layout verification program 32 is a computer program that is executed by the processor 11. The layout verification program 32 may be recorded on a computer-readable recording medium and read out from the recording medium to the memory device 12. The layout verification processing (Step S40) according to the present embodiment is realized by cooperation of the layout verification program 32 and the processor 11. More specifically, in accordance with instructions of the layout verification program 32, the processor 11 reads the layout data 23 and the DRC rule file 24 from the memory device 12 and then performs the verification of the layout data 23 (the plurality of cells) by reference to the DRC rule and the identification layers (Layer-A to Layer-C) of the layout data 23.

It is apparent that the present embodiment is not limited to the above embodiments and may be modified and changed without departing from the scope and spirit of the invention.

What is claimed is:

1. A layout verification program recorded on a computer-readable medium that, when executed, causes a computer to perform verification processing of a layout data of a semiconductor integrated circuit in which a plurality of cells are placed,
said verification processing comprising:
(A) reading said layout data and a design rule from a memory device,
wherein said layout data includes a first identification layer in which predetermined patterns are placed,
wherein said predetermined patterns include:
a first pattern placed on one corner of each of said plurality of cells; and
a second pattern placed parallel to one side of said each cell;
(B) identifying an orientation of said each cell by reference to said first pattern;
(C) identifying a direction of said each cell by reference to said second pattern; and
(D) verifying whether or not said identified orientation and direction meet said design rule.

2. The layout verification program according to claim 1,
wherein said layout data further includes a second identification layer indicating a type of said each cell,
wherein said verification processing further comprises identifying said type of each cell by reference to said second identification layer.

3. The layout verification program according to claim 2,
wherein TEXT defined by GDS-II format is given to said second identification layer of said each cell, and a boundary of said second identification layer of said each cell is away from a boundary of said each cell.

4. The layout verification program according to claim 2,
wherein said (D) verifying includes:
(D1) verifying whether or not types of cells adjacent to each other among said plurality of cells meet said design rule, based on said identified type.

5. The layout verification program according to claim 2,
wherein the respective first patterns of a predetermined number of cells adjacent to each other among said plurality of cells are adjacent to each other,
wherein said (D) verifying includes:
(D2) verifying whether or not respective orientations of said predetermined number of cells meet said design rule, based on said identified type and said respective first patterns adjacent to each other.

6. The layout verification program according to claim 2,
wherein said plurality of cells include a group of cells which are placed serially in a predetermined direction,
wherein said (D) verifying includes:
(D3) verifying whether or not a direction of said group of cells meets said design rule, based on said identified type and said second pattern.

7. The layout verification program according to claim 2,
wherein said plurality of cells include a group of cells which are placed serially in a predetermined direction,
wherein said (D) verifying includes:
(D4) verifying whether or not a number of cells included in said group of cells meets said design rule, based on said identified type and said second pattern.

8. A computer-readable medium on which a layout data of a semiconductor integrated circuit in which a plurality of cells are placed is recorded,
the layout data comprising: identification layers used for identifying each of said plurality of cells in layout verification,
wherein said identification layers include a first identification layer in which predetermined patterns are placed,
wherein said predetermined patterns include:
a first pattern placed on one corner of said each cell; and
a second pattern placed parallel to one side of said each cell.

9. The computer-readable medium according to claim 8,
wherein said identification layers further include a second identification layer indicating a type of said each cell.

10. The computer-readable medium according to claim 9,
wherein TEXT defined by GDS-II format is given to said second identification layer of said each cell, and a boundary of said second identification layer of said each cell is away from a boundary of said each cell.

11. The computer-readable medium according to claim 8,
wherein the respective first patterns of a predetermined number of cells adjacent to each other among said plurality of cells are adjacent to each other.

12. The computer-readable medium according to claim 8,
wherein said second pattern is placed adjacent to said one side of said each cell, and the respective second patterns of two cells adjacent to each other among said plurality of cells are adjacent to each other.

13. A computer-readable medium on which a cell data of a semiconductor integrated circuit is recorded,
the cell data comprising: identification layers used for identifying a cell in layout verification,
wherein said identification layers include a first identification layer in which predetermined patterns are placed,
wherein said predetermined patterns include:
a first pattern placed on one corner of said cell; and
a second pattern placed parallel to one side of said cell.

14. The computer-readable medium according to claim 13,
wherein said identification layers further include a second identification layer indicating a type of said cell.

15. The computer-readable medium according to claim 14,
wherein TEXT defined by GDS-II format is given to said second identification layer, and a boundary of said second identification layer is away from a boundary of said cell.

16. The computer-readable medium according to claim 13,
wherein said second pattern is placed adjacent to said one side of said cell.
